(19) United States
(12) Patent Application Publication
(10) Pub. No.: US 2002/0027909 A1
(43) Pub. Date: Mar. 7, 2002

(54) Multientity queue pointer chain technique

(75) Inventors: Kenneth W. Brinkerhoff, Mission Viejo, CA (US); Wayne P. Boese, Costa Mesa, CA (US); Robert C. Hutchins, Mission Viejo, CA (US); Stanley Wong, Santa Ana, CA (US)

Correspondence Address: BEYER WEAVER & THOMAS LLP, P.O. BOX 778, BERKELEY, CA, 94704-0778, US

(73) Assignee: Mariner Networks, Inc.

(21) Appl. No.: 09/896,431

(22) Filed: Jun. 28, 2001

Related U.S. Application Data
(60) Provisional application No. 60/215,558, filed on Jun. 30, 2000.

(51) Int. Cl. H04L 12/56

(52) U.S. Cl. 370/389; 370/395.1

(57) ABSTRACT

An architecture and techniques of the present invention combine multiple queues into a single multientity queue that functions in conjunction with a free queue embodied within the multientity queue. This multientity queue enables a device to significantly decrease overhead of memory clock cycles as data parcels are passed from process to process. The architecture implements a single queue with new pointers in addition to the “old” and “new” pointers associated with conventional queues. These new pointers represent processes or entities and can be referred to as first entity pointer, second entity pointer, third entity pointer and so on.

### RELATED APPLICATION DATA

The present application claims priority under 35 USC 119(e) from U.S. Provisional Patent Application No. 60/215,558 (Attorney Docket No. MO15-1001-Prov) entitled INTEGRATED ACCESS DEVICE FOR ASYNCHRONOUS TRANSFER MODE (ATM) COMMUNICATIONS; filed Jun. 30, 2000, and naming Brinkerhoff, et. al., as inventors (attached hereto as Appendix A); the entirety of which is incorporated herein by reference for all purposes.

### BACKGROUND OF THE INVENTION

1. Field of the Invention

The present invention relates generally to computer network devices and computer programming techniques. More specifically, it relates to techniques and components for moving data in data-forwarding network devices.

2. Background

Components in network devices that receive and then forward data in any type of computer network have grown more efficient over the years and have gone through a number of stages before reaching their present technological state. In the early stages of data packet forwarding technology, components, such as data switches, TDM framers, TDM cell processors, and the like, stored data in some type of memory, typically RAM. The components received data at one port and simply moved the data in RAM and then took the data out of RAM and forwarded the data out via an output port. Moving data from one memory or buffer to another, whether within a single component or between different components, consumed valuable memory clock cycles. Moreover, present data switching components contain several processes such as protocol engines and interworking functions which require that data be passed from process to process consuming even more memory clock cycles.

An early advancement in efficiently moving data through components involved passing pointers to the data instead of passing the data itself. The data packets or parcels are stored once in memory and pointers to the data are passed from component to component or process to process. Passing pointers to the data was far more efficient than passing the actual data which required taking the data in and out of memory.

As data-forwarding network devices grew more complex and multiple quality of service (QoS) levels emerged, multiple pointer queues were required. Pointers to data are taken from one queue, a technique known as dequeuing, and placed on another queue, known as queuing or re-queuing. Although pointers reduced read/write operations of data significantly, the process of handling pointers to the data has increased as operations grew more complex. The process of queuing and dequeuing of the pointers has become a major component of the overhead required in forwarding data. Indeed, general switch performance has become highly dependent on queue architecture. Multiple data queues combined with multiple component or processes acting on each data queue require that at least two sets of interrelated queues be linked to each other. Each time a component or process accesses or “touches” a data parcel, one or more pointers are queued and dequeued at least once and often more than once.

For each queue there is a pointer to the oldest and newest entry in the queue. Each entry in the queue contains another pointer to the next entry. Some queue architectures are bi-directional in that each entry contains pointers to the next entry and to the previous entry. Moving an entry from one queue to another (i.e., dequeuing and queuing) typically requires updating six, sometimes eight, pointers. That is, six read/write access operations are typically required to move an entry using pointers. In addition, since a high number of queues can potentially be involved, the pointers are often stored in RAM rather than in registers thereby adding to the overhead involved in moving entries.

A present process of dequeuing and enqueuing is described in the following example. A component or process receives a data parcel. The component has two queues, Free_Q and Q1, which have pointers Free_Q_old, Free_Q_new, Q1_old and Q1_new stored in registers or RAM addresses. The process determines the value of the pointer Free_Q_old, for example register #5. The process then reads the actual content of Free_Q_old, for example the number “6”. The register value of Free_Q_old is then determined based on the content of Free_Q_old. Thus, Free_Q_old is now register #6. The process then determines the value of Q1_new, for example register #4. The register value of Free_Q_old is then written into the memory for Q1_new. Thus, Free_Q_old is now register #5 and the number “5” is written into Q1_new (register #4). Q1_new now contains the number “5”. All together, there are six read and write accesses to registers or memory: three to remove the number “5” from the free queue (dequeing from the free queue) and three to write the number “5” to Q1 (enqueuing onto a new queue).

In light of the above, it will be appreciated that there is a continual need to improve upon the throughput and efficiency of data-forwarding network devices. With this objective, what is needed is a pointer queue architecture and process that reduces the number of read and write operations needed to move entries between queues, thereby minimizing the overhead for forwarding data in switches and other components in network devices.

### SUMMARY OF THE INVENTION

Additional objects, features and advantages of the various aspects of the present invention will become apparent from the following description of its preferred embodiments, which description should be taken in conjunction with the accompanying drawings. In one aspect of the present invention, a method of adding a data pointer to an empty multientity queue is described. A first content is read at a first address pointed to by a free queue old pointer in the multientity queue and this content is used as a second address from which a second content is read in the queue. The second content is then stored in the first address of the free queue old pointer. The first content is then stored into a third memory address pointed to by a first entity queue new pointer.

In one embodiment of the present invention, when the first content is stored into a third memory address, it is also stored in multiple other memory addresses corresponding to multiple entity queue new pointers. In another embodiment, the method is implemented in a data traffic handling device or data forwarding network device. Such a device can be configured to process data using either ATM protocol or Frame Relay, or both. In yet another embodiment, the method is implemented in a cell switch controlled by a scheduler wherein the cell switch implements the multientity queue.

In another aspect of the present invention, a method of adding a new data pointer to a populated multientity queue is described. A first content indicated by an old free queue pointer is read and used to access a second content in the multientity queue. The second content is then stored in the first free queue pointer. A third content is then read from a new first entity pointer and is used to access a first memory address in the multientity queue. The first content is then stored in the first memory address and in the new first entity pointer.

In another aspect of the present invention, a method of advancing a data pointer in a multientity queue is described. A first memory address is accessed using a first pointer corresponding to a first entity. A first content is then read from the first memory address and is used to access a second memory address in the queue. The second content is then read from the second memory address and is stored in a third memory address. The third memory address is accessible by a second pointer. The second content is stored directly in the third memory address.

In yet another aspect of the present invention, a method of releasing a data pointer associated with an entity in a multientity queue is described. A first content is read from a first memory address in the queue pointed to by a first pointer. The first content is used to access a second memory address in the queue. A second content is read from the second memory address. The second content is then stored in a second pointer wherein the second pointer corresponds to the last entity in the queue to process a data parcel. A third content is then read from a third memory address in the queue pointed to by a second pointer. The first content is then stored in the third memory address.

In yet another aspect of the present invention, a multientity queue structure is described. The queue structure has multiple data entries where each entry has at least one pointer to another entry in the queue. The queue also has a first free queue pointer pointing to a newest free queue entry and a second free queue pointer pointing to an oldest free queue entry. The queue structure also has at least one pair of data queue pointers representing a first entity. The pair of data queue pointers has a queue new pointer and a queue old pointer, and represents an entity receiving a data parcel, wherein the queue new pointer accepts a new value being inserted into the multientity queue and the queue old pointer releases an old value from the queue structure. This is done in such a way that when a data parcel is passed from the first entity to a second entity, the first entity does not have to dequeue the queue old pointer.

In yet another aspect of the present invention, a method of adding a data pointer corresponding to an entity in a queue is described. A first entity completes processing of a data parcel. A switch request is made to a first component capable of performing data pointer updates where the request is made by the first entity. A data pointer corresponding to a second entity is then updated by the first component. The data pointer is dequeued from the first entity and enqueued to the second entity in a single operation. The second entity is then alerted so that it can begin processing the data parcel.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 is an illustration of a multientity queue and sample pointers in accordance with one embodiment of the present invention.

FIG. 2 is a trace diagram of a process of transferring control of a data parcel from one entity to another entity using a multientity queue structure in accordance with one embodiment.

FIG. 3 is a flow diagram of a process of adding a new data pointer to an empty multientity queue in accordance with one embodiment of the present invention.

FIG. 4 is a flow diagram of a process of adding a new data pointer to an existing multientity queue in accordance with one embodiment of the present invention.

FIG. 5 is flow diagram of a process of advancing an existing data pointer to another entity in a multientity queue in accordance with one embodiment of the present invention.

FIG. 6 is a flow diagram of a process of releasing of a data pointer by an entity in a multientity queue to last handle or process a data parcel in accordance with one embodiment of the present invention.

FIG. 7 is a block diagram of a network device suitable for implementing the present invention.

FIG. 8 shows a block diagram of various inputs/outputs, components and connections of a system which may be used for implementing various aspects of the present invention.

### DETAILED DESCRIPTION OF THE PREFERRED EMBODIMENTS

In accordance with at least one embodiment of the present invention, a queueing architecture and process for manipulating queue entries are described in the various figures. Present components in data-forwarding network devices use pointers to access or pass data parcels from one component to the next instead of passing the entire data parcel in and out of memory. However, components have grown more complex as the throughput, versatility and demand on network devices have grown. Individual components (also referred to as processes, clients or entities) can have multiple data queues and moving entries from one queue to the next within a single component or between components can consume significant overhead. The processing required in terms of read/write operations to memory requires significant processing time and can adversely effect the performance of a network device.

According to a specific embodiment, the architecture and techniques of the present invention combine multiple queues into a single multientity queue that functions in conjunction with a free queue embodied within the single multientity queue. This multientity queue enables a device to significantly decrease overhead of memory clock cycles as data parcels are passed from process to process. The architecture implements a single queue with pointers in addition to the “old” and “new” pointers associated with conventional queues. These pointers represent processes or entities and can be referred to as first entity pointer, second entity pointer, third entity pointer and so on.

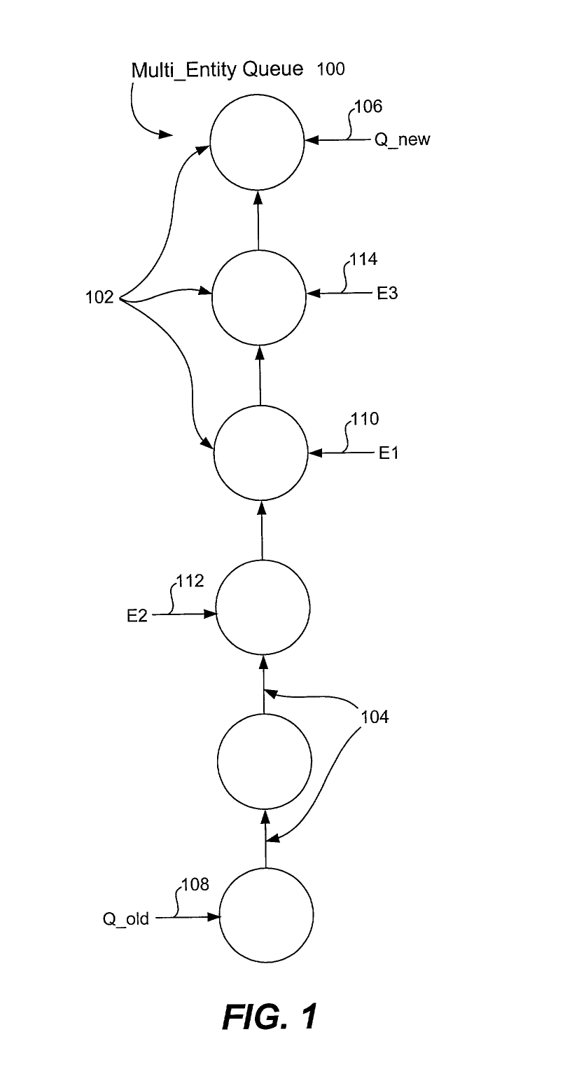

FIG. 1 is an illustration of a multientity queue and sample pointers in accordance with one embodiment of the present invention. A multientity queue (also referred to as a pointer list) 100 includes multiple nodes such as nodes 102 connected unidirectionally by links such as links 104. Links 104 can also be bidirectional in that content of nodes 104 can be moved up or down the queue. As with conventional queues, there is also a Q_new pointer 106 and a Q_old pointer 108. Q_new pointer 106 takes in new values being inserted into queue 100 and Q_old pointer 108 releases values from queue 100. For example, there are three pointers representing three entities using queue 100. Three pointers, pointer 110, pointer 112 and pointer 114 represent three entities E1, E2 and E3, respectively. The use of these entity pointers to reduce the number of read/write operations required to effeciently move data parcels using pointers between entities is described below.

In a specific embodiment, when an entity is done processing one data parcel and wants to pass it on and begin processing the next data parcel, the entity does not dequeue and requeue its pointers, but instead follows a chaining pointer to the next data parcel. By using this chaining pointer technique and a free queue in multientity queue 100, overhead processing by the entity is significantly reduced.

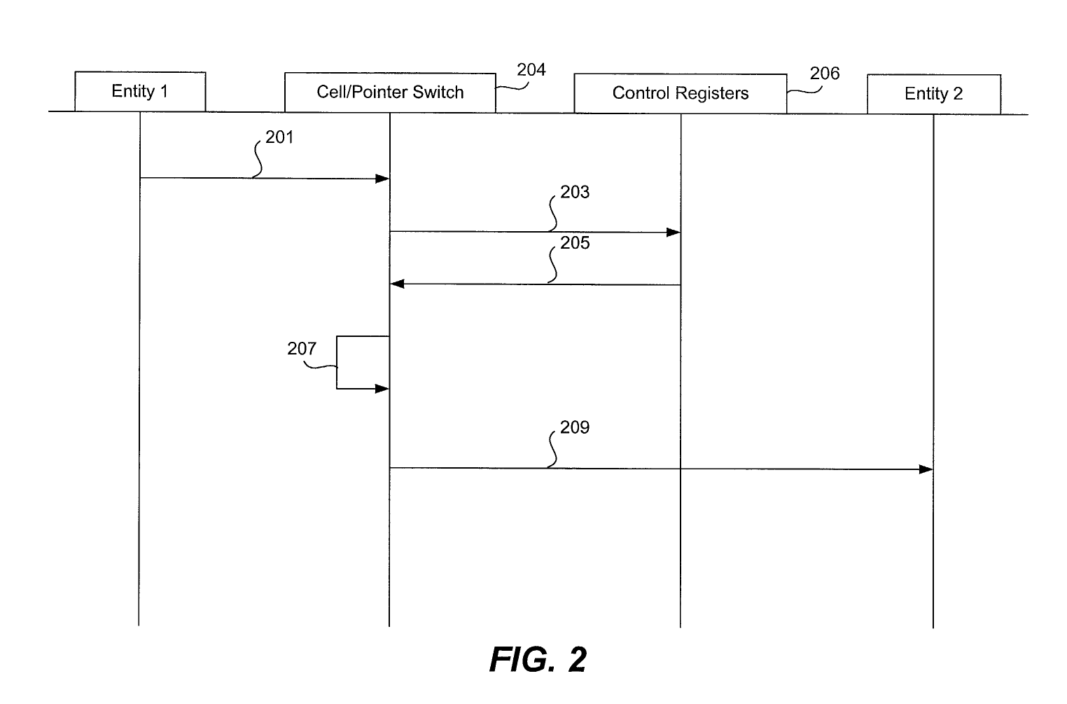

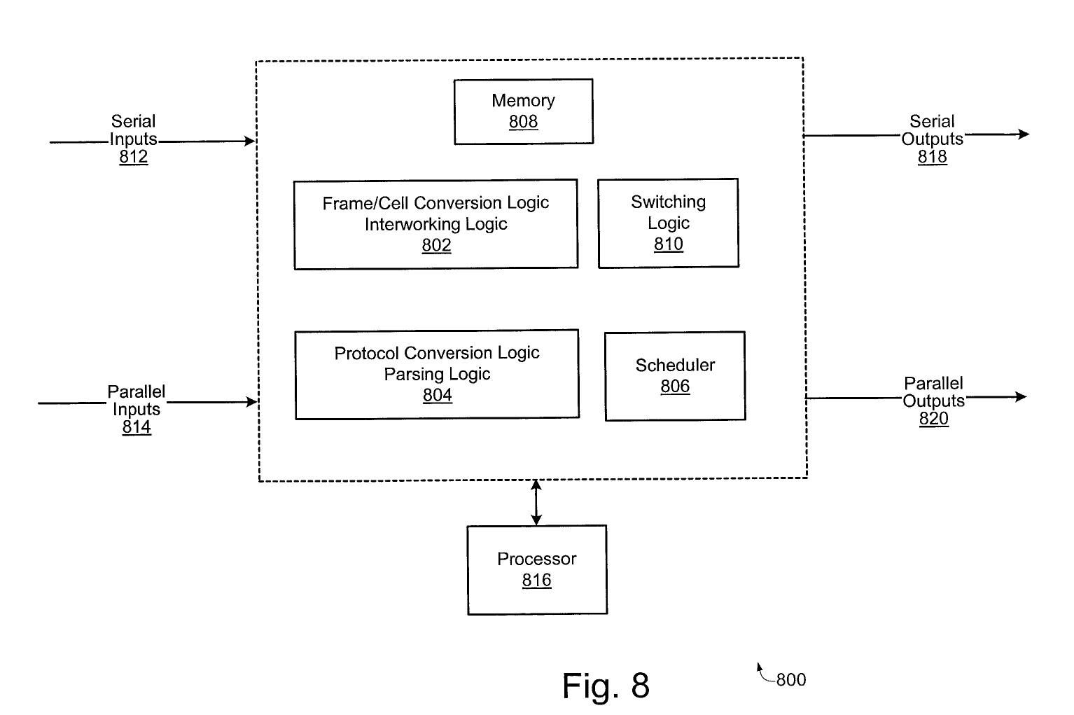

FIG. 2 is a trace diagram of a process of transferring control of a data parcel from one entity to another entity using a multientity queue structure in accordance with one embodiment. A first entity or transmitting entity has finished processing a data parcel and is ready to advance control to the next entity needing to manipulate the data. As described above, control of the data parcel is handed off from entity to entity (and, in some cases, within a single entity) using pointers to a data queue. An entity is any process, component, client or integrated circuit that receives, manipulates and transmits data. In a specific embodiment, examples of an entity are a TDM Framer, TDM Interworking component or TDM Cell Processor. When an entity wants to advance the data parcel to the next entity the transmitting entity makes a switch request as shown by arrow 201 to a component capable of determining the next entity and performing pointer updates. In a specific embodiment, this is a cell/pointer switch, represented by box 204 in FIG. 2, such as contained in switching logic 810 in FIG. 8. In other embodiments, such as in a non-ATM environment, the component may be a frame switch or equivalent component. Cell/pointer switch 204 receives the switch request from the first entity, Entity 1 in FIG. 2, on a particular incoming line card. In a specific embodiment, switch component 204 determines the identifier of Entity 1 based on the incoming line used by the entity.

Cell/pointer switch 204 examines a table or other data structure to determine the next entity in line for handling the data parcel handed off by Entity 1. In a specific embodiment, a command to get the identifier of the next entity is sent to control registers 206 as shown by arrow 203. For example, control registers 204 can be embodied in CPU configuration data that contains CPU configuration and control registers and other data structures. In a specific embodiment, ‘next entity’ information and other related data is stored in a channel switching table, one or more of which is stored in CPU 816. In other embodiments, information on which entity is next can be contained within cell/pointer switch 204 or similar component. In arrow 205 a response is sent back to cell/pointer switch 204 from control registers 206 indicating the next entity. In the illustration shown in FIG. 2, the next entity is Entity 2.

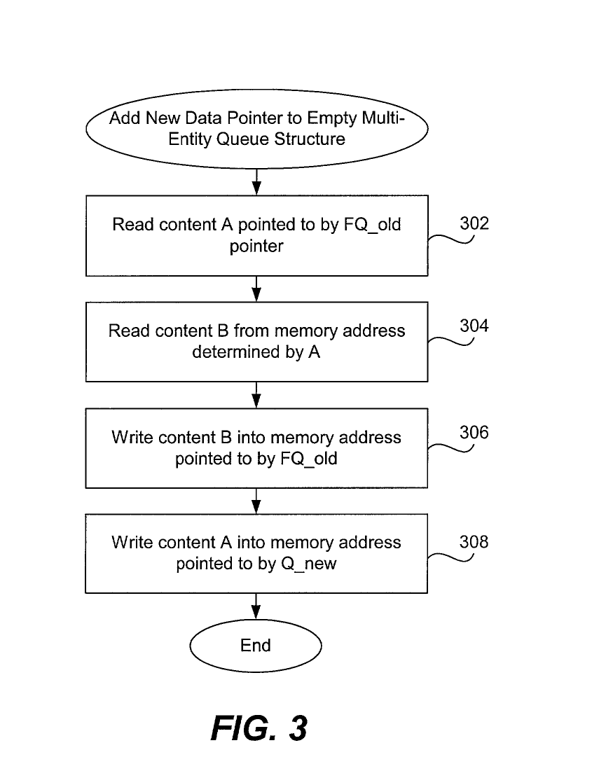

Cell/pointer switch 204 then updates the pointer for Entity 2 as indicated by arrow 207. This pointer can be referred to as a Q2 pointer and the pointer for Entity 1 can be referred to as a Q1 pointer. Arrow 207 starts from the switch and returns to the switch meaning that the changing of the entity pointers and free queue pointers are performed within the switch. Combined in this step are the dequeuing of Q1 and the enqueuing of Q2. A specific embodiment of a process in which the dequeuing and enqueuing of a pointer is shortened and where all relevant pointers are advanced is described in FIGS. 3 through 6 below. Four examples or scenarios are described: adding a new pointer to an empty queue; adding a new pointer to an existing queue; advancing an existing pointer to a next entity (e.g., from E1 to E2); and releasing a pointer by the last entity handling the data parcel. After the pointers in the multientity queue have been updated, the cell/pointer switch sends a notification or alert to Entity 2 notifying it that the entity can now begin processing the data parcel. This is shown by arrow 209.

FIG. 3 is a flow diagram of a process of adding a new data pointer to an empty multientity queue in accordance with one embodiment of the present invention. In a specific embodiment, the process described here and below is implemented in cell/pointer switch 204. In FIG. 3 a new pointer is added to an empty queue. The first three steps involve dequeuing from a free queue (“FQ”) and the remaining steps populate the contents of the data pointers in the queue. At step 302 the switch reads the contents, A, of the old pointer of the FQ, referred to as FQ_old, in the queue. For illustrative purposes content A is the value “1”.

At step 304 the switch uses the value of content A as a memory address and reads content B. In the example, the switch reads the content of B, such as the value “2”, at memory address 1 in the queue. At step 306 the content of B, the value “2” is written into the queue at FQ_old. By this stage content has been dequeued from the free queue. At step 308 content A, the value “1”, is written into the memory address pointed to by Q1_new, the new pointer for a first queue, Q1, representing, for example Entity 1. It is helpful to note that a single queue is being used, such as shown in FIG. 1, that is multientity and therefore can have numerous Qx_new, Qx_old pointer pairs.

At step 308 content A is written into memory addresses pointed to by other queues having pointers in the multientity queue structure. This process is often referred to as enqueuing. In a specific embodiment, these queues can represent separate entities. For example, there may be two other queues, Q2 and Q3, having a Q2_new pointer and a Q3_new pointer, each having the value of “1” once the process of adding a new data pointer into an empty multientity queue is complete.

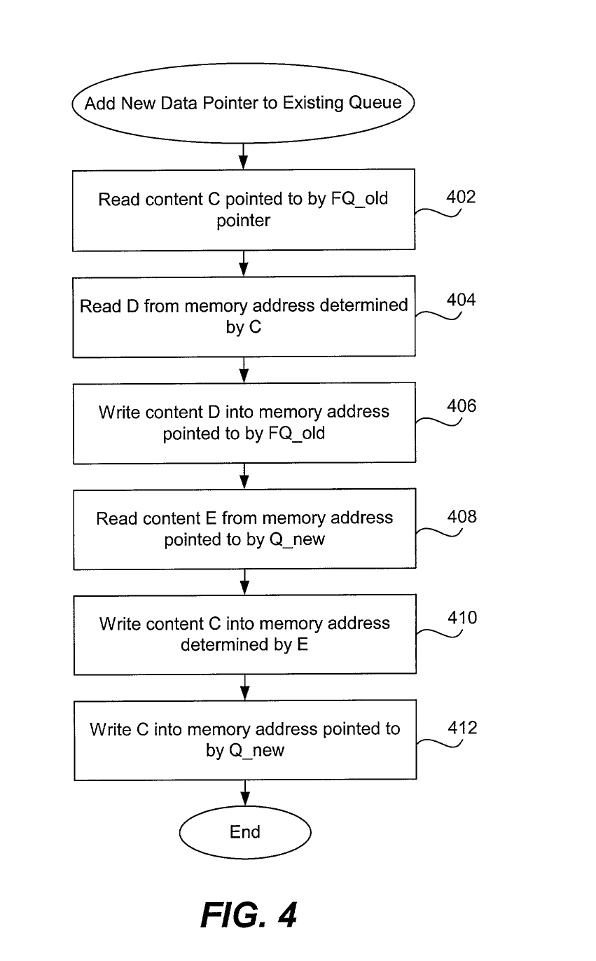

FIG. 4 is a flow diagram of a process of adding a new data pointer to an existing or non-empty multientity queue in accordance with one embodiment of the present invention. At step 402 the switch reads the content pointed to by FQ_old. For illustrative purposes, the content is represented by C and has a value of “2”. At step 404, the switch then uses content C, the value 2, as an address to read the next content value, for example content D which has the value 3. At step 406 content D, or the value 3, is written in as the content for FQ_old in the queue. Thus, FQ_old originally pointed to the value 2 and now points to or is said to contain the value 3.

At step 408 the switch reads content E from Q1_new pointer, where E is the value 1. At step 410 the switch uses the content E or value 1 as the next memory address to access. At memory address 1 in the multientity queue, content C or the value 2, is written to memory address 1. At step 412 the value 2, content C, is written into the memory address pointed to by Q1_new and the process is complete. Thus, Q1_new originally contained the value 1 and now contains the value 2.

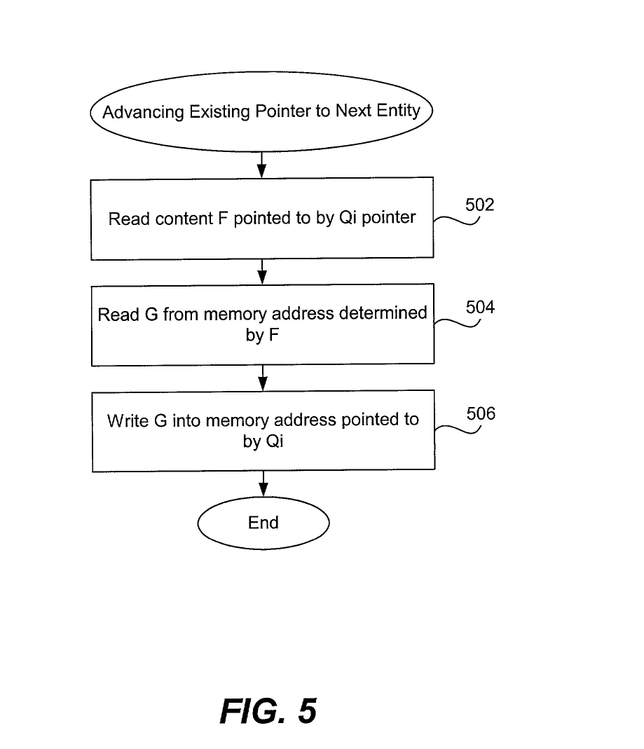

FIG. 5 is flow diagram of a process of advancing an existing data pointer to another entity in a multientity queue in accordance with one embodiment of the present invention. In a specific embodiment a pointer for a data parcel, such as Q1_old, is being passed from one entity to another entity by the cell/pointer switch, such as from Entity 1 to Entity 2, represented by Q2_new. At step 502 content F is read from the memory address pointed to by Qi. The sub-index i represents a queue having pointers in the multientity queue. Similar to steps 404 and 304 above, at step 504 the cell switch component uses the value of content F as the memory address in the queue that will be accessed next. For example, if content F is the value 1, the switch reads the content from memory address 1 in the queue. This content, G, has the value 2 and at step 506 the value 2 is written into the memory address pointed to by Qi, thus, Qi is now said to contain the value 2. In this process, the cell switch did not explicitly dequeue the previous entity; the new value for Qi was written directly into the new pointer.

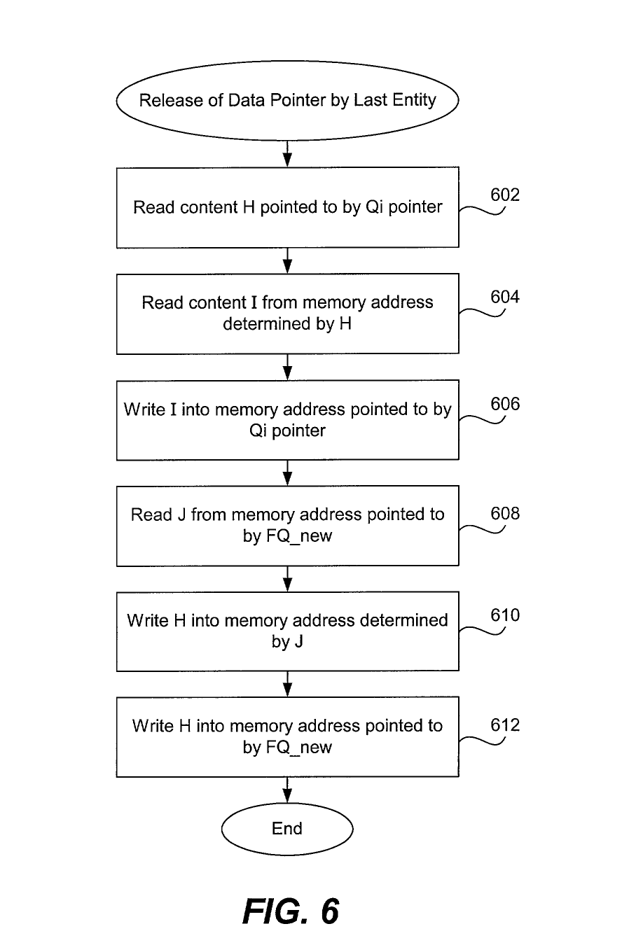

FIG. 6 is a flow diagram of a process of releasing of a data pointer by an entity in a multientity queue to last handle or process a data parcel in accordance with one embodiment of the present invention. At step 602 content H is read from the memory address pointed to by Qi. At step 604 the value of H, for example 1, is used to access memory address 1 in the queue. Content I, for example the value 2, is read from memory address 1. At step 606 content I is written into Qi_new, where Qi is the last entity in the queue to handle the data parcel.

At step 608 the cell switch reads content J from the FQ_new pointer in the free queue. For example, content J can have the value 14. Then, at step 610 content H or the value 1 is written into memory address 14, the memory address being determined by content J, as described in similar steps above in the other scenarios. At step 612 content H is also written into the memory address pointed to by FQ_new so that FQ_new is now said to contain the value 1. At this stage the last entity represented by pointer Qi has released the pointer to the data parcel and the process is complete.

System Configurations

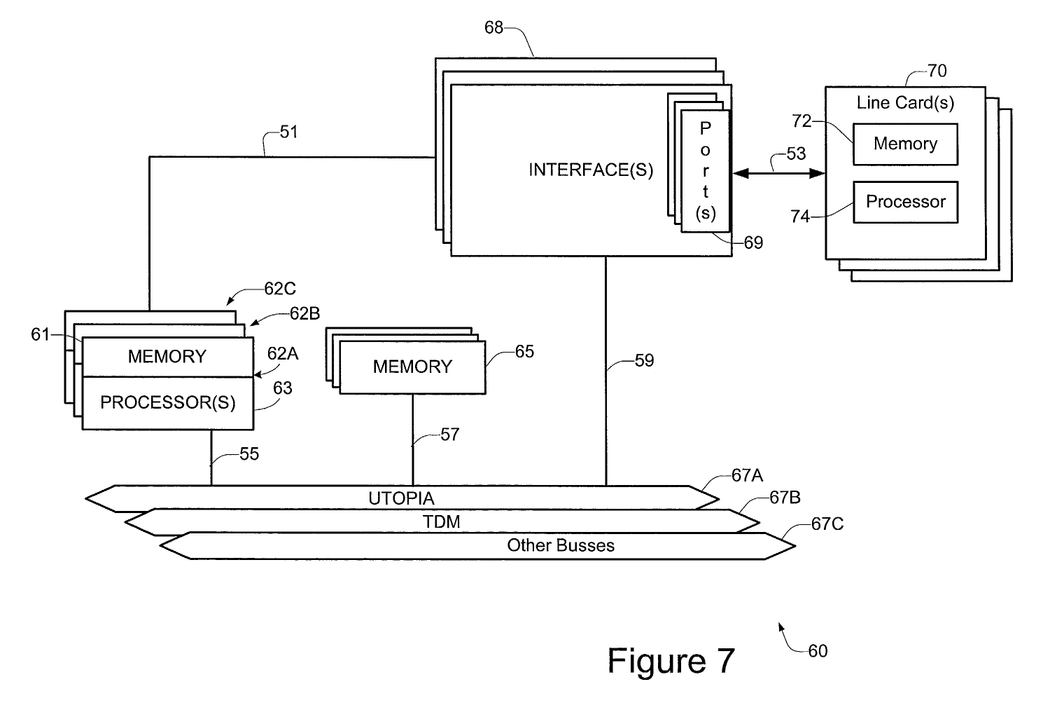

Referring now to FIG. 7, a network device 60 suitable for implementing the single multientity queue structure techniques of the present invention includes a master central processing unit (CPU) 62A, interfaces 68, and various buses 67A, 67B, 67C, etc., among other components. According to a specific implementation, the CPU 62A may correspond to the eXpedite ASIC, manufactured by Mariner Networks, of Anaheim, Calif.

Network device 60 is capable of handling multiple interfaces, media and protocols. In a specific embodiment, network device 60 uses a combination of software and hardware components (e.g., FPGA logic, ASICs, etc.) to achieve high-bandwidth performance and throughput (e.g., greater than 6 Mbps), while additionally providing a high number of features generally unattainable with devices that are predominantly either software or hardware driven. In other embodiments, network device 60 can be implemented primarily in hardware, or be primarily software driven.

When acting under the control of appropriate software or firmware, CPU 62A may be responsible for implementing specific functions associated with the functions of a desired network device, for example a fiber optic switch or an edge router. In another example, when configured as a multi-interface, protocol and media network device, CPU 62A may be responsible for analyzing, encapsulating, or forwarding packets to appropriate network devices. Network device 60 can also include additional processors or CPUs, illustrated, for example, in FIG. 7 by CPU 62B and CPU 62C. In one implementation, CPU 62B can be a general purpose processor for handling network management, configuration of line cards, FPGA logic configurations, user interface configurations, etc. According to a specific implementation, the CPU 62B may correspond to a HELIUM Processor, manufactured by Virata Corp. of Santa Clara, Calif. In a different embodiment, such tasks may be handled by CPU62A, which preferably accomplishes all these functions under partial control of software (e.g., applications software and operating systems) and partial control of hardware.

CPU 62A may include one or more processors 63 such as the MIPS, Power PC or ARM processors. In an alternative embodiment, processor 63 is specially designed hardware (e.g., FPGA logic, ASIC) for controlling the operations of network device 60. In a specific embodiment, a memory 61 (such as non-persistent RAM and/or ROM) also forms part of CPU 62A. However, there are many different ways in which memory could be coupled to the system. Memory block 61 may be used for a variety of purposes such as, for example, caching and/or storing data, programming instructions, etc.

According to a specific embodiment, interfaces 68 may be implemented as interface cards, also referred to as line cards. Generally, the interfaces control the sending and receiving of data packets over the network and sometimes support other peripherals used with network device 60. Examples of the interfaces that may be provided are Ethernet interfaces, frame relay interfaces, cable interfaces, DSL interfaces, token ring interfaces, IP interfaces, etc. In addition, various ultra high-speed interfaces can be provided such as fast Ethernet interfaces, Gigabit Ethernet interfaces, ATM interfaces, HSSI interfaces, POS interfaces, FDDI interfaces and the like. Generally, these interfaces include ports appropriate for communication with appropriate media. In some cases, they also include an independent processor and, in some instances, volatile RAM. The independent processors may control communications intensive tasks such as data parcel switching, media control and management, framing, interworking, protocol conversion, data parsing, etc. By providing separate processors for communications-intensive tasks, these interfaces allow the main CPU 62A to efficiently perform routing computations, network diagnostics, security functions, etc. Alternatively, CPU 62A may be configured to perform at least a portion of the above-described functions such as, for example, data forwarding, communication protocol and format conversion, interworking, framing, data parsing, etc.

In a specific embodiment, network device 60 is configured to accommodate a plurality of line cards 70. At least a portion of the line cards are implemented as hot-swappable modules or ports. Other line cards may provide ports for communicating with the general-purpose processor, and may be configured to support standardized communication protocols such as, for example, Ethernet or DSL. Additionally, according to one implementation, at least a portion of the line cards may be configured to support Utopia and/or TDM connections.

Although the system shown in FIG. 7 illustrates one specific network device of the present invention, it is by no means the only network device architecture on which the present invention can be implemented. For example, an architecture having a single processor that handles communications as well as routing computations, etc., may be used. Further, other types of interfaces and media could also be used with the network device such as TI, E1, Ethernet or Frame Relay.

According to a specific embodiment, network device 60 may be configured to support a variety of different types of connections between the various components. For illustrative purposes, it will be assumed that CPU 62A is used as a primary reference component in device 60. However, it will be understood that the various connection types and configurations described below may be applied to any connection between any of the components described herein.

According to a specific implementation, CPU 62A supports connections to a plurality of Utopia lines. As commonly known to one having ordinary skill in the art, a Utopia connection is typically implemented as an 8-bit connection which supports standardized ATM protocol. In a specific embodiment, the CPU 62A may be connected to one or more line cards 70 via Utopia bus 67A and ports 69. In an alternate embodiment, the CPU 62A may be connected to one or more line cards 70 via point-to-point connections 51 and ports 69. The CPU 62A may also be connected to additional processors (e.g. 62B, 62C) via a bus or point-to-point connections (not shown). As described in greater detail below, the point-to-point connections may be configured to support a variety of communication protocols including, for example, Utopia, TDM, etc.

As shown in the embodiment of FIG. 7, CPU 62A may also be configured to support at least one bi-directional Time-Division Multiplexing (TDM) protocol connection to one or more line cards 70. Such a connection may be implemented using a TDM bus 67B, or may be implemented using a point-to-point link 51.

In a specific embodiment, CPU 62A may be configured to communicate with a daughter card (not shown) which can be used for functions such as voice processing, encryption, or other functions performed by line cards 70. According to a specific implementation, the communication link between the CPU 62A and the daughter card may be implemented using a bi-directional TDM connection and/or a Utopia connection.

According to a specific implementation, CPU 62B may also be configured to communicate with one or more line cards 70 via at least one type connection. For example, one connection may include a CPU interface that allows configuration data to be sent from CPU 62B to configuration registers on selected line cards 70. Another connection may include, for example, an EEPROM arrow interface to an EEPROM memory 72 residing on selected line cards 70.

Additionally, according to a specific embodiment, one or more CPUs may be connected to memories or memory modules 65. The memories or memory modules may be configured to store program instructions and application programming data for the network operations and other functions of the present invention described herein. The program instructions may specify an operating system and one or more applications, for example. Such memory or memories may also be configured to store configuration data for configuring system components, data structures, or other specific non-program information described herein.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM), Flash memory PROMS, random access memory (RAM), etc.

In a specific embodiment, CPU 62B may also be adapted to configure various system components including line cards 70 and/or memory or registers associated with CPU 62A. CPU 62B may also be configured to create and extinguish connections between network device 60 and external components. For example, the CPU 62B may be configured to function as a user interface via a console or a data port (e.g. Telnet). It can also perform connection and network management for various protocols such as Simple Network Management Protocol (SNMP).

FIG. 8 shows a block diagram of various inputs/outputs, components and connections of a system 800 which may be used for implementing various aspects of the present invention. According to a specific embodiment, system 800 may correspond to CPU 62A of FIG. 7.

As shown in the embodiment of FIG. 8, system 800 includes cell switching logic 810 which operates in conjunction with a scheduler 806. In one implementation, cell switching logic 810 is configured as an ATM cell switch. In other implementations, switching logic block 810 may be configured as a packet switch, a frame relay switch, etc.

Scheduler 806 provides quality of service (QoS) shaping for switching logic 810. For example, scheduler 806 may be configured to shape the output from system 800 by controlling the rate at which data leaves an output port (measured on a per flow/connection basis). Additionally, scheduler 806 may also be configured to perform policing functions on input data. Additional details relating to switching logic 810 and scheduler 806 are described below.

As shown in the embodiment of FIG. 8, system 800 includes logical components for performing desired format and protocol conversion of data from one type of communication protocol to another type of communication protocol. For example, the system 800 may be configured to perform conversion of frame relay frames to ATM cells and vice-versa. Such conversions are typically referred to as interworking. In one implementation, the interworking operations may be performed by Frame/Cell Conversion Logic 802 in system 800 using standardized conversion techniques as described, for example, in the following reference documents, each of which is incorporated herein by reference in its entirety for all purposes

ATM Forum

(1) “B-ICI Integrated Specification 2.0”, af-bici-0013.003, December 1995

(2) “User Network Interface (UNI) Specification 3.1”, af-uni-0010.002, September 1994

(3) “Utopia Level 2, v1.0”, af-phy-0039.000, June 1995

(4) “A Cell-based Transmission Convergence Sublayer for Clear Channel Interfaces”, af-phy-0043.000, November 1995

Frame Relay Forum

(5) “User-To-Network Implementation Agreement (UNI)”, FRF. 1.2, July 2000

(6) “Frame Relay/ATM PVC Service Interworking Implementation Agreement”, FRF.5, April 1995

(7) “Frame Relay/ATM PVC Service Interworking Implementation Agreement”, FRF.8.1, December 1994

ITU-T

(8) “B-ISDN User Network Interface—Physical Layer Interface Specification”, Recommendation I.432, March 1993

(9) “B-ISDN ATM Layer Specification”, Recommendation 1.361, March 1993

As shown in the embodiment of FIG. 8, system 800 may be configured to include multiple serial input ports 812 and multiple parallel input ports 814. In a specific embodiment, a serial port may be configured as an 8-bit TDM port for receiving data corresponding to a variety of different formats such as, for example, Frame Relay, raw TDM (e.g., HDLC, digitized voice), ATM, etc. In a specific embodiment, a parallel port, also referred to as a Utopia port, is configured to receive ATM data. In other embodiments, parallel ports 814 may be configured to receive data in other formats and/or protocols. For example, in a specific embodiment, ports 814 may be configured as Utopia ports which are able to receive data over comparatively high-speed interfaces, such as, for example, E3 (35 megabits/sec.) and DS3 (45 megabits/sec.).

According to a specific embodiment, incoming data arriving via one or more of the serial ports is initially processed by protocol conversion and parsing logic 804. As data is received at logic block 804, the data is demultiplexed, for example, by a TDM multiplexer (not shown). The TDM multiplexer examines the frame pulse, clock, and data, and then parses the incoming data bits into bytes and/or channels within a frame or cell. More specifically, the bits are counted to partition octets to determine where bytes and frames/cells start and end. This may be done for one or multiple incoming TDM datapaths. In a specific embodiment, the incoming data is converted and stored as sequence of bits which also include channel number and port number identifiers. In a specific embodiment, the storage device may correspond to memory 808, which may be configured, for example, as a one-stack FIFO.

According to different embodiments, data from the memory 808 is then classified, for example, as either ATM or Frame Relay data. In other preferred embodiments, other types of data formats and interfaces may be supported. Data from memory 808 may then be directed to other components, based on instructions from processor 816 and/or on the intelligence of the receiving components. In one implementation, logic in processor 816 may identify the protocol associated with a particular data parcel, and assist in directing the memory 808 in handing off the data parcel to frame/cell conversion logic 802.

In the embodiment of FIG. 8, frame relay/ATM interworking may be performed by interworking logic 802 which examines the content of a data frame. As commonly known to one having ordinary skill in the art of network protocol, interworking involves converting address header and other information in from one type of format to another. In a specific embodiment, interworking logic 802 may perform conversion of frames (e.g. frame relay, TDM) to ATM cells and vice versa. More specifically, logic 802 may convert HDLC frames to ATM Adaptation Layer 5 (AAL 5) protocol data units (PDUs) and vice versa. Interworking logic 802 also performs bit manipulations on the frames/cells as needed. In some instances, serial input data received at logic 802 may not have a format (e.g. streaming video), or may have a particular format (e.g., frame relay header and frame relay data).

In at least one embodiment, the frame/cell conversion logic 802 may include additional logic for performing channel grooming. In one implementation, such additional logic may include an HDLC framer configured to perform frame delineation and bit stuffing. As commonly known to one having ordinary skill in the art, channel grooming involves organizing data from different channels in to specific, logical contiguous flows. Bit stuffing typically involves the addition or removal of bits to match a particular pattern.

According to at least one embodiment, system 800 may also be configured to receive as input ATM cells via, for example, one or more Utopia input ports. In one implementation, the protocol conversion and parsing logic 804 is configured to parse incoming ATM data cells (in a manner similar to that of non-ATM data) using a Utopia multiplexer. Certain information from the parser, namely a port number, ATM data and data position number (e.g., start-of-cell bit, ATM device number) is passed to a FIFO or other memory storage 808. The cell data stored in memory 808 may then be processed for channel grooming.

In specific embodiments, the frame/cell conversion logic 802 may also include a cell processor (not shown) configured to process various data parcels, including, for example, ATM cells and/or frame relay frames. The cell processor may also perform cell delineation and other functions similar to channel grooming functions performed for TDM frames. As commonly known in the field of ATM data transfer, a standard ATM cell contains 424 bits, of which 32 bits are used for the ATM cell header, eight bits are used for error correction, and 384 bits are used for the payload.

Once the incoming data has been processed and, if necessary, converted to ATM cells, the cells are input to switching logic 810. In a specific embodiment, switching logic 810 corresponds to a cell switch which is configured to route the input ATM data to an appropriate destination based on the ATM cell header (which may include a unique identifier, a port number and a device number or channel number, if input originally as serial data).

According to a specific embodiment, the switching logic 810 operates in conjunction with a scheduler 806. Scheduler 806 uses information from processor 816 which provides specific scheduling instructions and other information to be used by the scheduler for generating one or more output data streams. The processor 816 may perform these scheduling functions for each data stream independently. For example, the processor 816 may include a series of internal registers which are used as an information repository for specific scheduling instructions such as, expected addressing, channel index, QoS, routing, protocol identification, buffer management, interworking, network management statistics, etc.

Scheduler 806 may also be configured to synchronize output data from switching logic 810 to the various output ports, for example, to prevent overbooking of output ports. Additionally, the processor 816 may also manage memory 808 access requests from various system components such as those shown, for example, in FIGS. 7 and 8 of the drawings. In a specific embodiment, a memory arbiter (not shown) operating in conjunction with memory 808 controls routing of memory data to and from requesting clients using information stored in processor 816. In a specific embodiment, memory 808 includes DRAM, and memory arbiter is configured to handle the timing and execution of data access operations requested by various system components such as those shown, for example, in FIGS. 7 and 8 of the drawings.

Once cells are processed by switching logic 810, they are processed in a reverse manner, if necessary, by frame/cell conversion logic 802 and protocol conversion logic 804 before being released by system 800 via serial or TDM output ports 818 and/or parallel or Utopia output ports 820. According to a specific implementation, ATM cells are converted back to frames if the data was initially received as frames, whereas data received in ATM cell format may bypass the reverse processing of frame/cell conversion logic 802.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed:

1. A method of modifying at least one data pointer associated with a multientity queue, the method comprising:
reading a first content at a first address of a free queue old pointer in the multientity queue;
using the first content as a second address to read a second content at the second address;
storing the second content into the first address of the free queue old pointer; and
storing the first content into a third memory address of a first entity queue new pointer.

2. The method of claim 1 wherein the multientity queue is initially empty.

3. A method as recited in claim 1 wherein storing the first content into a third memory address further comprises storing the first content into a plurality of memory addresses corresponding to a plurality of entity queue new pointers.

4. A method as recited in claim 1 wherein the method is implemented in a traffic handling device

5. A method as recited in claim 4 wherein the traffic handling device is configured to process data using Asynchronous Transfer Mode (ATM) protocol.

6. A method as recited in claim 4 wherein the traffic handling device is configured to process data using Frame Relay protocol.

7. A method as recited in claim 4 wherein the traffic handling device is configured to process data using one of Frame Relay protocol and Asynchronous Transfer Mode (ATM) protocol.

8. A method as recited in claim 1 wherein the method is implemented in a cell switch.

9. A method as recited in claim 8 wherein the cell switch implements the multientity queue and the cell switch is controlled by a scheduler.

10. A computer program product including a computer usable medium having computer readable code embodied therein, the computer readable code including computer code for implementing the method of claim 1.

11. A method of modifying at least one data pointer associated with a queue, the method comprising:
reading a first content indicated by an old free queue pointer;
using the first content to access a second content in the multientity queue;
storing the second content in the first free queue pointer;
reading a third content from a new first entity pointer;
using the third content to access a first memory address in the queue; and
storing the first content in the first memory address and in the new first entity pointer.

12. The method of claim 11 wherein the queue is initially populated with content.

13. A method as recited in claim 11 further comprising determining an identifier of the first entity based on the incoming line used by the first entity.

14. A method as recited in claim 11 further comprising the first component examining a switching table to determine the next entity to receive the data parcel.

15. A method as recited in claim 11 wherein the method is implemented in a traffic handling device.

16. A method as recited in claim 11 wherein the traffic handling device is configured to process data using Asynchronous Transfer Mode (ATM) protocol.

17. A method as recited in claim 11 wherein the traffic handling device is configured to process data using Frame Relay protocol.

18. A method as recited in claim 11 wherein the traffic handling device is configured to process data using one of Frame Relay protocol and Asynchronous Transfer Mode (ATM) protocol.

19. A method as recited in claim 11 wherein the method is implemented in a cell switch.

20. A method as recited in claim 11 wherein the cell switch implements the multientity queue and the cell switch is controlled by a scheduler.

21. A computer program product including a computer usable medium having computer readable code embodied therein, the computer readable code including computer code for implementing the method of claim 11.

22. A method of modifying at least one data pointer associated with a multientity queue, the method comprising:
accessing a first memory address using a first pointer corresponding to a first entity;
reading a first content at the first memory address;
using the first content to access a second memory address in the queue;
reading the second content from the second memory address; and
storing the second content in a third memory address accessible by a second pointer, wherein the second content is stored directly in the third memory address.

23. A method as recited in claim 22 wherein the method is implemented in a traffic handling device.

24. A method as recited in claim 22 wherein the traffic handling device is configured to process data using Asynchronous Transfer Mode (ATM) protocol.

25. A method as recited in claim 22 wherein the traffic handling device is configured to process data using Frame Relay protocol.

26. A method as recited in claim 22 wherein the traffic handling device is configured to process data using one of Frame Relay protocol and Asynchronous Transfer Mode (ATM) protocol.

27. A method as recited in claim 22 wherein the method is implemented in a cell switch.

28. A method as recited in claim 22 wherein the cell switch implements the multientity queue and the cell switch is controlled by a scheduler.

29. A computer program product including a computer usable medium having computer readable code embodied therein, the computer readable code including computer code for implementing the method of claim 22.

30. A method of modifying at least one data pointer associated with an entity in a multientity queue, the method comprising:
reading a first content from a first memory address in the queue pointed to by a first pointer;
using the first content to access a second memory address in the queue;
reading from the second memory address a second content;
storing the second content in a second pointer wherein the second pointer corresponds to the last entity in the queue to process a data parcel;
reading a third content from a third memory address in the queue pointed to by a second pointer; and
storing the first content in the third memory address.

31. A method as recited in claim 30 wherein the method is implemented in a traffic handling device.

32. A method as recited in claim 30 wherein the traffic handling device is configured to process data using Asynchronous Transfer Mode (ATM) protocol.

33. A method as recited in claim 30 wherein the traffic handling device is configured to process data using Frame Relay protocol.

34. A method as recited in claim 30 wherein the traffic handling device is configured to process data using one of Frame Relay protocol and Asynchronous Transfer Mode (ATM) protocol.

35. A method as recited in claim 30 wherein the method is implemented in a cell switch.

36. A method as recited in claim 30 wherein the cell switch implements the multientity queue and the cell switch is controlled by a scheduler.

37. A computer program product including a computer usable medium having computer readable code embodied therein, the computer readable code including computer code for implementing the method of claim 30.

38. A system for storing a multientity queue data structure embodied in a computer-readable medium, said system comprising:
at least one processor;
memory;
said at least one processor being configured to store in said memory a plurality of data structures, including a multientity queue data structure, said multientity queue data structure comprising:
a plurality of data entries, an entry having at least one pointer to another entry in the queue;
a first free queue pointer pointing to a newest free queue entry and a second free queue pointer pointing to an oldest free queue entry;
at least one pair of data queue pointers representing a first entity, the pair of data queue pointers having a queue new pointer and a queue old pointer, the pair of data queue pointers representing an entity receiving a data parcel, wherein the queue new pointer accepts a new value being inserted into the multientity queue and the queue old pointer releases an old value from the multientity queue, such that when a data parcel is passed from the first entity to a second entity, the first entity does not dequeue the queue old pointer.

39. A method of adding a data pointer corresponding to an entity in a queue, the method comprising:
completing processing of a data parcel by a first entity;
making a switch request to a first component capable of performing data pointer updates, the request being made by the first entity;
updating a data pointer for a second entity by the first component wherein the data pointer is dequeued from the first entity and enqueued to the second entity in single operation; and
alerting the second entity so that the second entity can begin processing the data parcel.

40. A computer program product including a computer usable medium having computer readable code embodied therein, the computer readable code including computer code for implementing the method of claim 39.

41. A system for modifying at least one data pointer associated with a multientity queue, the system comprising:
a memory storing a multientity queue; and
a system capable of executing computer program instructions for:
reading a first content at a first address of a free queue old pointer in the multientity queue;
using the first content as a second address to read a second content at the second address;
storing the second content into the first address of the free queue old pointer; and
storing the first content into a third memory address of a first entity queue new pointer.

42. The method of claim 41 wherein the multientity queue is initially empty.

43. A system as recited in claim 41 wherein the system is a data traffic handling device.

44. A system as recited in claim 43 wherein the data traffic handling device is configured to process data using Asynchronous Transfer Mode (ATM) protocol.

45. A system as recited in claim 43 wherein the data traffic handling device is configured to process data using Frame Relay protocol.

46. A system as recited in claim 43 wherein the data traffic handling device is configured to process data using one of Frame Relay protocol and Asynchronous Transfer Mode (ATM) protocol.

47. A system as recited in claim 41 wherein the system is a cell switch.

48. A system as recited in claim 47 wherein the cell switch implements the multientity queue and the cell switch is controlled by a scheduler.

49. A system for modifying at least one data pointer associated with a queue, the system comprising:
a memory storing a multientity queue; and
a system capable of executing computer program instructions for:
reading a first content indicated by an old free queue pointer;
using the first content to access a second content in the multientity queue;
storing the second content in the first free queue pointer;
reading a third content from a new first entity pointer;
using the third content to access a first memory address in the queue; and
storing the first content in the first memory address and in the new first entity pointer.

50. The method of claim 49 wherein the queue is initially populated with content.

51. A system as recited in claim 49 further comprising a switching table used for determining the next entity to receive the data parcel.

52. A system as recited in claim 49 wherein the system is implemented in a data traffic handling device.

53. A system as recited in claim 52 wherein the data traffic handling device is configured to process data using Asynchronous Transfer Mode (ATM) protocol.

54. A system as recited in claim 52 wherein the data traffic handling device is configured to process data using Frame Relay protocol.

55. A system as recited in claim 52 wherein the data traffic handling device is configured to process data using one of Frame Relay protocol and Asynchronous Transfer Mode (ATM) protocol.

56. A system as recited in claim 49 wherein the system is a cell switch.

57. A system for modifying at least one data pointer associated with a multientity queue, the system comprising:
a memory storing a multientity queue; and
a system capable of executing computer program instructions for:
accessing a first memory address using a first pointer corresponding to a first entity;
reading a first content at the first memory address;
using the first content to access a second memory address in the queue;
reading the second content from the second memory address; and
storing the second content in a third memory address accessible by a second pointer, wherein the second content is stored directly in the third memory address.

58. A system as recited in claim 57 wherein the system is a data traffic handling device.

59. A system as recited in claim 58 wherein the data traffic handling device is configured to process data using Asynchronous Transfer Mode (ATM) protocol.

60. A system as recited in claim 58 wherein the data traffic handling device is configured to process data using Frame Relay protocol.

61. A system as recited in claim 58 wherein the data traffic handling device is configured to process data using one of Frame Relay protocol and Asynchronous Transfer Mode (ATM) protocol.

62. A system as recited in claim 57 wherein the system is a cell switch.

63. A system as recited in claim 57 wherein the cell switch implements the multientity queue and the cell switch is controlled by a scheduler.

64. A system for modifying at least one data pointer associated with an entity in a multientity queue, the system comprising:
a memory storing a multientity queue; and
a system capable of executing computer program instructions for:
reading a first content from a first memory address in the queue pointed to by a first pointer;
using the first content to access a second memory address in the queue;
reading from the second memory address a second content;
storing the second content in a second pointer wherein the second pointer corresponds to the last entity in the queue to process a data parcel;
reading a third content from a third memory address in the queue pointed to by a second pointer; and
storing the first content in the third memory address.

65. A system for adding a data pointer corresponding to an entity in a queue, the system comprising:
a memory storing a multientity queue; and
a system capable of executing computer program instructions for:
completing processing of a data parcel by a first entity;
making a switch request to a first component capable of performing data pointer updates, the request being made by the first entity;
updating a data pointer for a second entity by the first component wherein the data pointer is dequeued from the first entity and enqueued to the second entity in single operation; and
alerting the second entity so that the second entity can begin processing the data parcel.

66. A system for modifying at least one data pointer associated with a multientity queue, the system comprising:
means for reading a first content at a first address of a free queue old pointer in the multientity queue;
means for using the first content as a second address to read a second content at the second address;
means for storing the second content into the first address of the free queue old pointer; and
means for storing the first content into a third memory address of a first entity queue new pointer.
